(19) United States
(12) Patent Application Publication
(10) Pub. No.: US 2023/0399774 A1
(43) Pub. Date: Dec. 14, 2023

(54) CARBON NANOWIRE, A FABRIC, A MANUFACTURING METHOD THEREFOR, AND AN ADDITIVE FOR A FABRIC

(71) Applicant: City University of Hong Kong, Kowloon (HK)

(72) Inventors: Jin Shang, Kowloon (HK); Tianqi Wang, Kowloon (HK); Mingzhe Sun, Kowloon (HK)

(21) Appl. No.: 17/835,392

(22) Filed: Jun. 8, 2022

(51) Int. Cl. D01F 9/12; D01D 5/00; D02G 3/16; D02G 3/44; D01F 1/10; B82Y 40/00; B82Y 30/00

(52) U.S. Cl. CPC D01F 9/12; D01D 5/0015; D02G 3/16; D02G 3/449; D01F 1/10; B82Y 40/00; B82Y 30/00; D10B 2101/122; D10B 2401/13; D10B 2501/042

(57) ABSTRACT

A carbon nanowire contains a photocatalytic metal-organic framework (MOF) in the form of a nanoparticle. Methods herein may produce a nanowire, fabrics, nonwoven fabrics, products, etc. containing such a nanowire, and/or the MOF having antibacterial and/or pathogenic efficacy upon irradiation.

### FIELD OF THE INVENTION

The present invention relates to carbon nanowires, fabrics and methods of making carbon nanowires and fabrics. More specifically, the present invention relates to carbon nanowires, fabrics with improved features and properties, additive compounds for such improved fabrics, and methods of making improved carbon nanowires and fabrics.

### BACKGROUND

Fabrics, and nonwoven fabrics especially are formed of individual filaments, such as threads and wires, and are used for a multitude of products such as, for example, clothing, filtration, etc. However, while capable of physically trapping and potentially holding airborne pathogens such as bacteria, most existing fabrics and their derived products on the market are incapable of actually killing such bacteria once trapped, self-cleaning, self-disinfecting, etc. Very few fabric-based products, such as masks, are active in any way and are most typically passive air filters whose effectivity is solely based on their filtration of various particle sizes.

Some active fabrics; or filtration materials, exist. However, they are typically TiO₂-based materials responsive to UV radiation (see, for example, CN 110538656 A to Zhang and the Research Center for Eco-Environmental Sciences, Chinese Academy of Sciences published on Dec. 6, 2019), but ineffective for visible and IR irradiation ranges. However, the use of such TiO₂-based fabrics in, for example, facial masks and surgical masks are limited by concerns about skin cancer potentially caused by exposure to UV light, and low sunlight conversion efficiency due to the very low proportion of UV in the typical solar spectrum (4%).

Other materials used in visible-light responsive fabrics and masks, include noble metals (e.g. Au and Pt) and tantalum oxynitride (TaON) co-loaded nonwoven fabrics (see, for example, CN 103990483 A to Zhang, et al., University of Donghua, published on Aug. 20, 2014) and ZnO loaded traditional surgical masks, etc. However, it has been found, for example, that the noble metal-TaON fabric requires high material and energy costs, due to the use of expensive noble metal and is obtained via a two-stage calcination at high temperatures. ZnO masks potentially possess an inherent safety concern due to the cytotoxicity caused by Zn²⁺ ion release, because Zn²⁺ ions are known to potentially cause skin irritation, inflammation, etc. in certain subjects. Thus, the these visible-light responsive personal protective products are not preferred.

The production and consumption of protective fabrics, masks, clothing, etc. to prevent or ward off bacteria and viruses is especially increasing during pandemics, cold and flu season, etc. However, current materials are either not photoactive/photocatalytic, not self-cleansing, and/or may not protect against both microorganisms as well as hazardous chemicals.

Accordingly, the need exists for fabrics; or nonwoven fabrics, with improved photocatalytic effects, improved disinfection, improved filtration, the ability to neutralize/reduce both biological and chemical threats, and/or reduced cytotoxicity. It is also desirable to provide an additive for a fabric which has an improved safety profile and photocatalytic properties without exposure to UV light.

### SUMMARY OF THE INVENTION

An embodiment of the present invention relates to a carbon nanowire containing a photocatalytic metal-organic framework in the form of nanoparticles.

An embodiment of the present invention relates to a method for producing a metal organic framework (MOF) nanoparticles by the steps of dissolving Zn(NO₃)₂·6H₂O in methanol for form a Zn(NO₃)₂·6H₂O solution, dissolving 2-methylimidazole in methanol to form a 2-methylimidazole solution, adding the Zn(NO₃)₂·6H₂O solution to the 2-methylimidazole solution to form a reaction solution, stirring the reaction solution for from about 5 minutes to about 48 hours to form a milky white precipitate, washing the milky white precipitate with methanol from about 1 time to about 10 times to forma washed precipitate, drying the washed precipitate at from about 35° C. to about 150° C. to form a dried metal-organic framework precipitate and thermally-treating the dried precipitate at from about 125° C. to about 700° C. for from about 5 minutes to about 48 hours to form a thermally treated metal-organic framework nanoparticles.

An embodiment of the present invention relates to a method for forming a nanowire containing metal-organic framework nanoparticles by the steps of providing a metal-organic framework nanoparticles produced according to the method herein, combining the metal-organic framework nanoparticles, polyvinylidene fluoride and dimethylformamide to form a mixture, stirring the mixture to form a homogenous suspension, and electro-spinning the homogenous suspension to form a nanowire.

Without intending to be limited by theory, it is believed that the present invention provides a metal organic framework, a nanowire, a fabric, a nonwoven fabric, a filter, etc. which possesses a strong oxidation potential for, for example, oxidizing bacterial cell walls, cell membranes, biological proteins, etc. Accordingly, the products produced with the materials and methods herein may provide one or more benefits such as improved photocatalytic effects, improved disinfection, improved filtration, the ability to neutralize/reduce both biological and chemical threats, and/or reduced cytotoxicity. It is also desirable to provide an additive for a fabric which has an improved safety profile and photocatalytic properties without exposure to UV light.

### BRIEF DESCRIPTION OF THE DRAWINGS

FIG. 1 shows an electrospinning process for MOF fabric fabrication.

FIG. 2a shows the scanning electron microscopy of bare fabric, and FIG. 2b shows that of MOF fabric, and FIG. 2c shows the transmission electron microscopy of MOF photocatalyst nanoparticles.

FIG. 3 shows the UV-vis diffuse reflectance spectroscopy of spectra of ZIF-8 and ZIF-8-T fabrics.

FIG. 4 shows the photocatalytic air disinfection against E. coli K-12 bacterium by bare, ZIF-8, and ZIF-8-T fabrics under visible light.

FIG. 5 shows the filtration efficiency against PM 2.5 and bacterium of ZIF-8-T fabric in the dark.

The figures herein are for illustrative purposes only and are not necessarily drawn to scale.

### DESCRIPTION OF THE PREFERRED EMBODIMENTS

Unless otherwise specifically provided, all tests herein are conducted at standard conditions which include a room and testing temperature of 25° C., sea level (1 atm.) pressure, pH 7, and all measurements are made in metric units. Furthermore, all percentages, ratios, etc. herein are by weight, unless specifically indicated otherwise. It is understood that unless otherwise specifically noted, the materials compounds, chemicals, etc. described herein are typically commodity items and/or industry-standard items available from a variety of suppliers worldwide.

As used herein, the term “ZIF-8” indicates a nanoparticle having the formula C₈H₁₂N₄Zn.

As used herein, the term “ZIF-8-T” indicates a thermally-treated ZIF-8 nanoparticle.

An embodiment of the invention herein includes a carbon nanowire comprising a photocatalytic metal-organic framework (MOF) in the form of a nanoparticle. It is believed that the MOF herein possesses photocatalytic properties which broadly range from, for example, the UV spectra (λ>400 nm) to the visible light spectra to the IR spectra (λ>700 nm). It is further believed that when excited by light, the MOF generates charge carriers (i.e., holes and electrons) and their induced reactive oxygen species such as superoxide radical (.O₂⁻), hydroxide radical (.OH), singlet oxygen (¹O₂), hydrogen peroxide (H₂O₂), etc., capable of killing pathogenic microorganisms. Furthermore, it is believed that the photocatalytic MOF maintains or may even improve its photocatalytic properties when add to and/or included within a particle, a nanoparticle, a nanowire, a fabric, a nonwoven fabric, an article, a filter, etc.

It is further believed that the photocatalytic MOF herein may kill and/or inactivate one or more germs and/or microorganisms such as, for example, bacteria, protozoa, viruses, and a combination therein; or bacteria; or Gram-positive bacteria; or Gram-negative bacteria; or E. coli. It is believed that the present invention may provide, for example, a MOF fabric endowed with photocatalytic activity upon sunlight and even indoor light irradiation. In addition to microorganisms, it is believed that this MOF fabric may effectively inactivate, for example, hazardous organic pollutants, provide desirable self-cleaning properties, etc. The particles, nanoparticles, nanowires, fabrics, nonwonven fabrics, etc. herein may be applied to various products such as a mask; a facial mask; a surgical mask; protective clothing; a sheet; a tablecloth; a wallpaper; a curtain; a sunshade; a tent; a filter; a tablecloth, etc. In an embodiment herein, product is an air filter, such as, for example, for a HVAC system, a personal fan, an air conditioner, a vacuum cleaner, etc. Without intending to be limited by theory, it is believed that the MOF herein, and the various products containing the MOF herein, may cause photocatalyzed creation of reactive oxygen species that in turn oxidize susceptible bonds in, for example, bacterial membranes, cell walls, proteins, etc. so as to inhibit and/or destroy the bacteria.

The particles, nanoparticles, nanowires, fabrics, nonwoven fabrics, various products herein, etc. may further be combined with other functional materials such as, for example, other photocatalysts, heavy metals/ions (e.g., Ag, Ag⁺, etc.), chitosan, etc.

In an embodiment herein, the metal-organic framework has the (estimated) empirical formula C₇H₉N₄OZn.

The MOF and/or the nanoparticle herein may have a size of from about 2 nm to about 990 nm; or from about 5 nm to about 750 nm; or from about 10 nm to about 500 nm; or from about 20 nm to about 200 nm. Without intending to be limited by theory, it is believed that when the nanoparticles are too large, they will tend to aggregate, resulting in an overall reduction of active surface area and reduced photocatalytic and oxidation efficiency. Conversely, if the nanoparticles are too small, it is believed that the nanoparticles may block the fabric pores, leading to a reduction of air permeability.

In an embodiment herein, the nanowire may have a diameter of from about 2 nm to about 2 μm; or from about 5 nm to about 1.5 μm; or from about 10 nm to about 1 μm; or from about 20 nm to about 400 nm.

In an embodiment herein, the mass ratio of the nanoparticle; fabric is from about 1:1000 to about 1:2; or from about 1:100 to about 1:3; or from about 1:40 to about 1:4.

An embodiment of the present invention relates to a method for producing a metal-organic framework nanoparticle via the steps of dissolving Zn(NO)₂·6H₂O in methanol for form a Zn(NO₃)₂·6H₂O solution, dissolving 2-methylimidazole in methanol to form a 2-methylimidazole solution, adding the Zn(NO₃)₂·6H₂O solution to the 2-methylimidazole solution to form a reaction solution, stirring the reaction solution for from about 5 minutes to about 48 hours to form a milky white precipitate, washing the milky white precipitate with methanol form about 1 time to about 10 times to form a washed precipitate, drying the washed precipitate at from about 35° C. to about 150° C. for about from 2 min to about 96 hours to form a dried metal-organic framework precipitate, and thermally-treating the dried precipitate at from about 125° C. to about 700° C. for from about 5 minutes to about 48 hours to form the thermally treated metal-organic framework nanoparticles.

Without intending to be limited by theory, it is believed that the present invention provides a metal-organic framework (MOF) particle; or a nanoparticle; or a nanowire; or a fabric; or a nonwoven fabric; or an article, or a combination thereof with a wide-spectral response and/or low cytotoxicity. It is further believed that the thermally treated ZIF-8 (ZIF-8-T) MOF nanoparticles, which may show wide absorption from the ultraviolet (UV) light region to the infrared (IR) light region may provide a photocatalytic activity, low biotoxicity, high mechanical strength, tunable air permeability, and outstanding photocatalytic air disinfection performance to a particle; or a nanoparticle; or a nanowire; or a fabric; or a nonwoven fabric, or a combination thereof.

Furthermore, it is believed that the present invention is especially well-suited for combination with, or into a hydrophobic fiber, for example, polyvinyl fluoride, the fiber; or fabric; or nonwoven fabric; or article, will continue to exhibits high hydrophobic properties. When formed into an article such as, but not limited to, a filter, the fabric; or nonwoven fabric, also is believed to effectively sequester and protect from particulate pollution, potentially achieving over 97.7% filtering efficacy against PM 2.5 (particulate matter having a diameter of less than 2.5 micrometers) particles. It is believed that the MOF, nanowires, fabric; and/or nonwoven fabric, herein is applicable to a wide range of products while providing great potential for disinfection, decomposition of VOCs (volatile organic compounds), energy generation (e.g., CO₂ reduction to CO or other compounds to CH₄, splitting water to produce oxygen and hydrogen gasses, etc.), and/or cleaning.

In an embodiment of the method herein, the adding step takes from about 10 seconds to about 60 seconds; or from about 15 seconds to about 50 seconds; or from about 20 seconds to about 45 seconds. Without intending to be limited by theory, it is believed that the results of the method herein are improved when the Zn(NO₃)₂·6H₂O solution is quickly added to the 2-methylimidazole solution to form the reaction solution so as to quickly form the desired MOF particle sizes and maximize the surface area thereof.

An embodiment of the invention herein includes a method for producing a metal-organic framework nanoparticle where the stirring step is from about 5 minutes to about 48 hours; or from about 15 minutes to about 2.5 hours; or from about 30 minutes to about 2 hours; or from about 45 minutes to about 1.5 hours. It is believed that if the stirring timing is too short then the precipitation will be incomplete, where as if it is too long, then this results in wasted time, energy, inefficiently-slow production, etc.

In an embodiment herein, the manufacturing process further contains a step of centrifuging the milky white precipitate at from about 5000 rpm to about 20000 rpm for about 1 minute to about 15 minutes to separate it from the reaction solution prior to the washing step.

An embodiment of the invention herein includes a method for producing a metal-organic framework nanoparticle where the washing step with methanol is from about 1 to about 10 times; or from about 2 to about 8 times; or from about 3 to about 6 times. Without intending to be limited by theory, it is believed that it is important to remove excess and unreacted raw materials which could otherwise contaminate the end product, potentially increase cytotoxicity, etc.

An embodiment of the invention herein includes a method for producing a metal-organic framework nanoparticle by the drying step occurs at from about 35° C. to about 150° C.; or from about 40° C. to about 85° C.; or from about 45° C. to about 75° C. to form a dried MOF precipitate. Without intending to be limited by theory, it is believed that if the drying temperature is too high, then the MOF and/or the nanoparticle structure may be negatively-affected, whereas if the drying temperature is too low, then the production process and solvent removal process becomes slower and less efficient.

An embodiment of the invention herein includes a method for producing a metal-organic framework nanoparticle where the thermally-treating step is from about 125° C. to about 700° C.; or from about 150° C. to about 275° C.; or from about 175° C. to about 250° C. Without intending to be limited by theory, it is believed that this thermal treatment step may significantly reduce the cytotoxicity of the nanoparticle; or the MOF nanoparticle; or the photocatalytic MOF nanoparticle. Without intending to be limited by theory, it is believed that thermally-treating the dried precipitate may change the ligand structure and thereby increase the MOF stability. This in turn may reduce the release rate of Zn²⁺ ions. It is also believed that the thermal treating step may serve to generate unique functional groups such as, for example, isocyanate groups, on the MOF surface which then enables the MOF to possess wide-spectra-responsive photocatalytic activity.

An embodiment of the invention herein includes a method for producing a metal-organic framework nanoparticle where the thermally-treating step lasts from about 5 minutes and about 48 hours; or from about 25 minutes to about 20 hours; or from about 40 minutes to about 15 hours; or from about 45 minutes to about 10 hours so as to remove any moisture, solvent, methanol, etc.

An embodiment of the invention herein includes a metal-organic framework nanoparticle produced according to the method described herein. The MOF nanoparticle may be further processed into a nanowire, a photocatalytic nanowire, a fabric, etc. Thus, an embodiment of the invention herein includes a fabric; or a nonwoven fabric; or a photocatalytic fabric; or a photocatalytic nonwoven fabric, including therein the metal-organic framework nanoparticle. In an embodiment herein, a fabric; or a nonwoven fabric, contains the nanowire described herein.

An embodiment of the present invention also includes a method for forming a nanowire comprising a metal-organic framework nanoparticle by the steps of providing a metal-organic framework nanoparticle as described herein, combining the metal-organic framework nanoparticle, polyvinylidene fluoride and dimethylformamide to form a mixture, stirring the mixture to form a homogenous suspension, and electro-spinning the homogenous suspension to form a nanowire. Without intending to be limited by theory, it is believed that these nanowires are especially preferred as the MOF and/or nanoparticles are evenly and/or stably spread throughout the fiber.

Without intending to be limited by theory, it is believed that the electro-spinning of the homogenous suspension into a nanowire may, for example, easily control the porosity of the fabric; or the nonwoven fabric. In an embodiment herein, the electrospinning contains the step of extruding the nanowire from an orifice, such as a syringe needle tip, having a round (circular) Φ=0.33 mm±10 nm orifice. In an embodiment herein, the shape of the orifice is selected from the group of a circle, a square, an oval, a rectangle, a dumbbell, a polyhedron, and a combination thereof; or a circle.

Another embodiment of the invention herein includes a method for forming a nanowire as described herein, further comprising the steps of extruding the homogenous suspension from a needle to form a strand and elongating the strand while voltage is applied to the extruding homogenous suspension as it may provide high specific surface area and good air permeability. In an embodiment herein, a voltage of from about 1 kV to about 100 kV; or from about 3 kV to about 75 kV; or from about 5 kV to about 50 kV is applied to the homogenous suspension; or to the extrusion droplet during extrusion. The voltage should be sufficient to overcome the threshold voltage of about 1 kV/cm.

In an embodiment herein the extrusion of the homogenous suspension is at a rate of from about 0.001 mL/min to about 10 mL/min; or from about 0.002 mL/min to about 5 mL/min; or from about 0.005 mL/min to about 2 mL/min.

In an embodiment of the invention herein, a nanowire is formed by the invention herein. It is believed that when formed into a nanowire, the invention herein may possess a high relative surface area and also be able to be further formed into, for example, a fabric; or a nonwoven fabric, etc. This in turn may be formed into a product or article, for example, a facial mask; or a surgical mask, containing the fabric; or nonwoven fabric. In an embodiment herein, the fabric; or nonwoven fabric, may also be formed into a filter; or an air filter, etc. to both capture and inactivate microorganisms, or to filter and neutralize organic contaminants.

An embodiment of the present invention include a method of disinfecting a fabric; or a fabric containing a nanowire; or a fabric containing a photocatalytic nanowire, as described herein, or a nonwoven fabric; or a nonwoven fabric containing a nanowire; or a nonwoven fabric containing a photocatalytic nanowire, as described herein, by including the step of exposing the fabric to UV light, visible light, and/or infrared light; or light having a wavelength of from about 10 nm to about 2500 nm; or from about 10 nm to about 1000 nm; or from about 10 nm to about 400 nm.

### Example 1

Preparation of ZIF-8-T MOF Nanoparticles

To produce the ZIF-8-T MOF nanoparticles, 0.7332 g of Zn(NO₃)₂·6H₂O is dissolved in 50 mL methanol to form a Zn(NO₃)₂·6H₂O solution. Next, 1.6225 g of 2-methylimidazole is dissolved in 50 mL methanol to form a 2-methylimidazole solution. Then the Zn(NO₃)₂·6H₂O solution is rapidly added into the 2-methylimidazole solution within 30 seconds to form a reaction solution. The reaction solution is stirred for 1 h at room temperature.

A milky white precipitate forms in the reaction solution. The milky white precipitate is centrifuged at 5000-20000 r/min for 1-15 min and washed with methanol 5 times to remove any remaining reaction solution to form a washed precipitate (i.e., the ZIF-8 MOF). The ZIF-8 MOF is dried at 60° C. for at least 2 h to form a dried precipitate. The dried precipitate is thermally-treated at 200° C. in an oven under ambient air pressure and atmosphere for from 1 to 7 hours to generate a metal-organic framework nanoparticle (i.e., ZIF-8-T MOF nanoparticles).

### Example 2

Fabric Preparation

Preparation of ZIF-8-T loaded fabric: to prepare the fabric of the present invention, 0.9 g of the MOF nanoparticles (ZIF-8-T MOF nanoparticles) from Example 1 are added to 1.5 g of polyvinylidene fluoride (PVDF) and 10 mL of dimethylformamide (DMF) to form a mixture. The mixture is stirred in a sealed bottle for 8 hours at room temperature to form a homogeneous suspension. The homogenous suspension is transferred into a 20-mL syringe (with a Φ=0.33 mm stainless-steel needle).

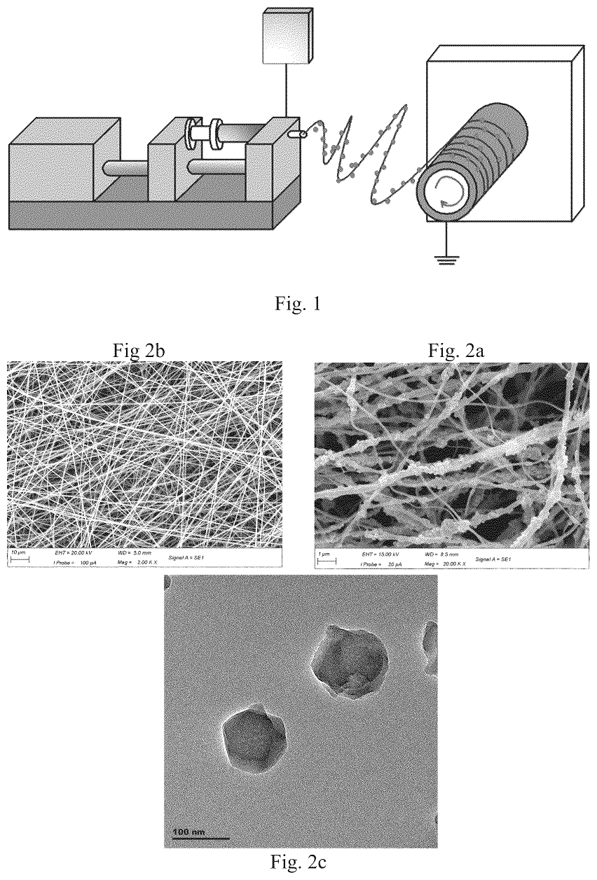

FIG. 1 shows a schematic diagram of an embodiment of a fiber manufacturing process. In FIG. 1 a syringe is fixed in an electro-spinning apparatus where the distance between roller collector and the syringe tip is about 20 cm. The syringe contains a round 0=0.33 mm stainless-steel syringe needle. The voltage of 15 kV is applied to the liquid droplet during extrusion to form the nanowire. The extrusion speed is 0.01 mL/min. Under the high electric field provided by the high voltage supply, the droplet on the syringe needle tip is extruded and elongated by the syringe pump.

When the electric traction force exceeds the surface tension force of a polymeric droplet, the Taylor Cone forms to produce a nanofiber containing the MOF (i.e., a MOF nanofiber). In the present invention, the photocatalytic ZIF-8-T MOF nanoparticles are contained in the nanofiber and loaded on the nanofiber surface during the electro-spinning process. The polymeric droplets containing MOF nanoparticles extruded from the orifice (i.e., the spinneret) at a controlled rate elongate under the influence of the high electric field. During this process it is believed that the polymeric droplets overcome the homogenous suspension's surface tension and solidify to form filamentous fibers containing MOF nanoparticles. The MOF nanowire and/or fabric is then collected on the rotating collector.

FIG. 2a shows a SEM (scanning electron microscopy) image of an embodiment of a fabric formed from a MOF nanofiber.

Preparation of Bare Fabric:

The bare fabric without MOF nanoparticles is prepared using the same procedures as described above, except that no MOF nanoparticles are added in the first step.

FIG. 2b shows a SEM image of an embodiment of a bare fabric.

FIG. 2c shows a TEM (transmission electron microscopy) image of an embodiment of a MOF nanoparticle.

FIG. 2a and FIG. 2b show the morphology of the fabrics as prepared in Example 2. FIG. 2a shows that in the ZIF-8-T fabric, the ZIF-8-T nanoparticles (dimeter=about 90 nm) are evenly loaded on the nanowires. FIG. 2b shows that the bare fabric contains numerous overlapping and intertwined nanowires with the diameter of about 100-400 nm). The transmission electron microscopy (TEM) image in FIG. 2c shows that the ZIF-8-T nanoparticles' morphology possess a roughly rhombic dodecahedron morphology, with the particle size of about 90 nm in diameter.

### Example 3

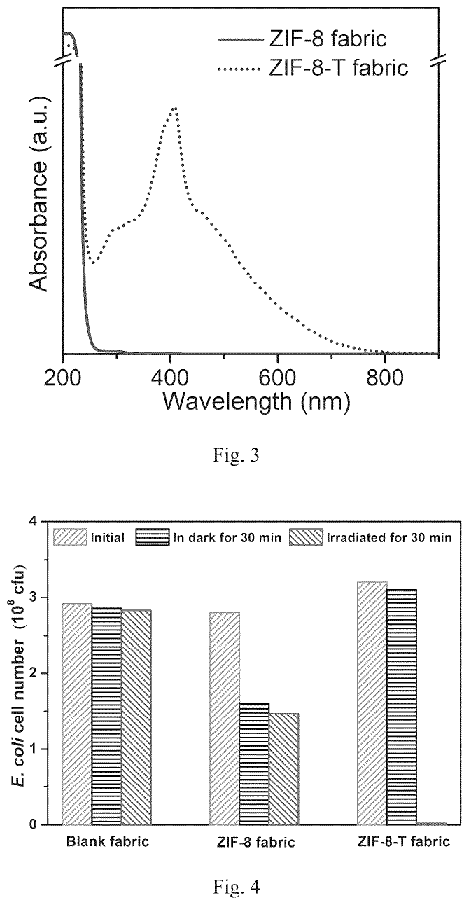

The light absorption ability of MOF fabrics is examined by UV-vis diffuse reflectance spectroscopy (DRS). FIG. 3 shows the absorbance of a ZIF-8 nanoparticle-containing fabric compared to a ZIF-8-T nanoparticle-containing fabric measured by a Lambda 950 spectrometer (PerkinElmer, U.S.A.), with the excitation wavelength ranging from 200 to 800 nm. Specifically, the ZIF-8 nanoparticle-containing fabric only shows absorbance in the UV region (i.e., at about <270 nm), while the ZIF-8-T nanoparticle-containing fabric exhibits strong absorbance at UV wavelengths, visible wavelengths, and near infrared (NIR) wavelengths.

### Example 4

Photocatalytic bacterial inactivation comparison: Three separate sample fabric membranes (each being 15 cm²) are prepared with a blank fabric, a ZIF-8 nanoparticle-containing fabric, and a ZIF-8-T nanoparticle-containing fabric. E. coli K-12-containing aerosols with the diameter of 1-5 μm generated from 10⁹ (colony-forming unit) CFU·mL⁻¹ of bacteria suspension are prepared as model-infected aerosols. Each fabric is exposed to a 0.3 mL·min⁻¹ of aerosol flow for 5 min. The bacteria-contaminated fabric is either placed in the dark for 30 min. or irradiated by visible light (xenon lamp, λ≥400 nm, 300 W) for 30 min. Both fabrics are subsequently fully washed with 25 mL of saline solution to collect all the adhered bacteria. Finally, 100 μL of the collected bacterial suspension is diluted and evenly spread onto nutrient agar plates and incubated at 37° C. for 18 hours in the dark to calculate the bacterial population.

The photocatalytic activity of fabrics is investigated by inactivating E. coli K-12 bacterium in air under visible light. After being exposed to E. coli K-12 aerosol flow for 5 min. the initial cell density on fabric surface is around 3×10⁹ CFU. Then, the bacteria contaminated fabric is placed in dark for 30 min to evaluate the cytotoxicity, or irradiated by visible light (an indoor xenon lamp, λ≥400 nm, 300 W) for 30 min to examine the photocatalytic activity.

As shown in FIG. 4, the blank fabric without photocatalyst cannot inactivate bacteria either in dark or being irradiated. It is shown that the ZIF-8-T nanoparticle-containing fabric exhibits outstanding photocatalytic bacterial inactivation performance, with 98.13% E. coli K-12 cells inactivated within 30 min under visible light. It is also shown that the decrease in cell density in the dark demonstrates a negligible cytotoxicity of ZIF-8-T nanoparticle-containing fabric. In contrast, the ZIF-8 (i.e., without thermal treatment) nanoparticle-containing fabric has high cytotoxicity, as suggested by the significant cell population decrease (42.86%) even when in the dark for 30 min. Furthermore, the visible-light photocatalytic antibacterial activity of ZIF-8 nanoparticle-containing fabric is lower than the ZIF-8 nanoparticle-containing fabric because the bacterial inactivation under visible light is only slightly improved (by 4.64%) as compared with the cytotoxicity in dark.

These experimental results show that especially the ZIF-8-T nanoparticle containing fabric, can efficiently inactivate 3.2×10⁸ cfu/mL of E. coli bacteria within 30 min under indoor visible light.

### Example 5

Filtration Efficiency Testing:

The filtration efficiency of the ZIF-8-T nanoparticle-containing fabric against PM 2.5 and E. coli bacterium (typically about 2 μm long and 0.25-1 μm in diameter) is tested by forming the fabric into a filter (diameter=12 cm). PM 2.5 and E. coli aerosols are produced in a closed box connected to two Aerosol monitors (DustTrak II Aerosol Monitor 8532) fitted with an inbuilt suction pump. Specifically, for monitoring the PM 2.5 concentrations during the filter efficiency evaluation these aerosol monitors are fitted with a 2.5 μm filter which allow only PM 2.5 to pass through. One of the aerosol monitors (DT-1) directly connects to the box and serves as a control measuring the total PM 2.5 and E. coli bacterium concentrations in the closed box without filtration, while the other Aerosol monitor (DT-2) is connected through the filter and measures such concentrations after filtration.

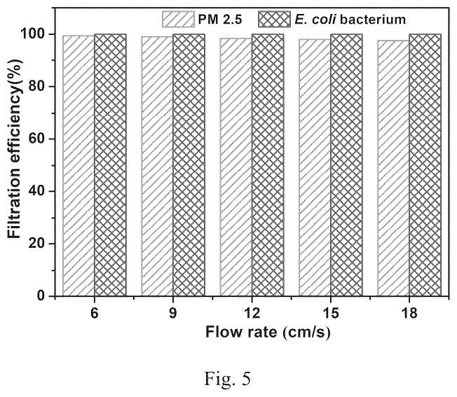

FIG. 5 shows the filtration efficiency of an embodiment of a ZIF-8-T nanoparticle-containing fabric in the dark. FIG. 5 shows that the ZIF-8-T nanoparticle-containing fabric exhibits high filtration performance against fine particulate matter (e.g., PM 2.5) of about 97.7˜99.5% and E. coli K-12 bacterial cells of about 100% under flow rate ranging from 6 to 18 cm's. Without intending to be limited by theory, it is believed that the combination of high capture efficiency (see, e.g., FIG. 5) and the high kill-rate (see, e.g., FIG. 4) makes ZIF-T-8 nanoparticle-containing fabric especially useful and effective to both capture and kill microorganisms, and especially germs and/or microorganisms. Thus, there is high potential to use the fabric herein in personal protective equipment such as a mask, a surgical mask, a facial mask, etc.

It is understood that the above only illustrates and describes examples whereby the present invention may be carried out, and that modifications and/or alterations may be made thereto without departing from the spirit of the invention.

It is also be understood that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable subcombination.

All references specifically cited herein are hereby incorporated by reference in their entireties. However, the citation or incorporation of such a reference is not necessarily an admission as to its appropriateness, citability, and/or availability as prior art to/against the present invention.

What is claimed is:

1) A carbon nanowire comprising a photocatalytic metal-organic framework in the form of a nanoparticle.

2) The carbon nanowire according to claim 1, wherein the metal-organic framework has the empirical formula: C₇H₉N₄OZn.

3) The carbon nanowire according to claim 1, wherein the nanoparticle has a size of from about 2 nm to about 990 nm.

4) A method for producing a metal-organic framework nanoparticle comprising the steps of:
A) dissolving Zn(NO₃)₂·6H₂O in methanol for form a Zn(NO₃)₂·6H₂O solution;
B) dissolving 2-methylimidazole in methanol to form a 2-methylimidazole solution;
C) adding the Zn(NO₃)₂·6H₂O solution to the 2-methylimidazole solution to form a reaction solution;
D) stirring the reaction solution for from about 5 minutes to about 48 hours to form a milky white precipitate;
E) washing the milky white precipitate with methanol from about 1 time to about 10 times to form a washed precipitate;
F) drying the washed precipitate at from about 35° C. to about 150° C. to form a dried metal-organic framework precipitate; and
G) thermally-treating the dried precipitate at from about 125° C. to about 700° C. for from about 5 minutes to about 48 hours to form a thermally treated metal-organic framework nanoparticle.

5) The method for producing a metal-organic framework nanoparticle according to claim 4, wherein the adding step takes from about 10 seconds to about 60 seconds.

6) The method for producing a metal-organic framework nanoparticle according to claim 4, wherein the stirring step is from about 15 minutes to about 2.5 hours.

7) The method for producing a metal-organic framework nanoparticle according to claim 4, wherein the washing step with methanol is from about 2 to about 7 times.

8) The method for producing a metal-organic framework nanoparticle according to claim 4, wherein the drying step is from about 40° C. to about 85° C.

9) The method for producing a metal-organic framework nanoparticle according to claim 4, wherein the thermally-treating step is from about 150° C. to about 275° C.

10) The method for producing a metal-organic framework nanoparticle according to claim 4, wherein the thermally-treating step is from about 40 minutes to about 15 hours.

11) A metal-organic framework nanoparticle produced according to the method of claim 4.

12) A fabric comprising the metal-organic framework nanoparticle according to claim 11.

13) A method for forming a nanowire comprising a metal-organic framework nanoparticle comprising the steps of:
A) providing a metal-organic framework nanoparticle produced according to the method of claim 4;
B) combining the metal-organic framework nanoparticle, poly vinylidene fluoride and dimethylformamide to form a mixture;
C) stirring the mixture to form a homogenous suspension; and
D) electro-spinning the homogenous suspension to form a nanowire.

14) The method for forming a nanowire according to claim 13, further comprising the steps of:
E) dispensing the homogenous suspension from a needle to form a strand; and
F) elongating the strand within an electric field.

15) A nanowire formed according to claim 13.

16) A fabric comprising the nanowire formed according to claim 15.

17) A facial mask comprising the fabric according to claim 16.

18) A method of disinfecting a fabric according to claim 16, comprising the step of exposing the fabric to visible light.

19) A fabric comprising a carbon nanowire according to claim 1.

20) A method of disinfecting a fabric according to claim 1, comprising the step of exposing the fabric to UV light, visible light and/or infrared light.
